(19) United States
(12) Patent Application Publication
(10) Pub. No.: US 2013/0318442 A1
(43) Pub. Date: Nov. 28, 2013

(54) AUDIO GEAR COMPARISON SYSTEM AND METHOD

(71) Applicant: Phase 2 Interactive, LLC, Minneapolis, MN (US)

(72) Inventor: Stephen LAWSON, Minneapolis, MN (US)

(73) Assignee: Phase 2 Interactive, LLC, Minneapolis, MN (US)

(21) Appl. No.: 13/896,541

(22) Filed: May 17, 2013

Related U.S. Application Data
(60) Provisional application No. 61/651,206, filed on May 24, 2012.

(51) Int. Cl. G06F 3/16

(52) U.S. Cl. CPC G06F 3/167
USPC 715/716; 381/92

(57) ABSTRACT

A system and method that allow users to directly compare audio gear, for example microphones and other items in the audio recording chain (e.g. preamplifiers, cables, amplifiers, etc.), against the same instance of recorded material and equidistant from the source material. The system and method allow a user to make the comparison against “bed music” tracks giving the user a representation of how the compared items of audio gear will perform in the end product or music mix. By providing the user the ability to make an “apples-to-apples” comparison between audio gear, users are able to determine the audio gear that best meets their needs before making a purchase.

### FIELD

This disclosure relates to a system and method for comparing audio gear, including but not limited to microphones, preamplifiers, amplifiers, cables, and other items in the audio recording chain, to facilitate selection and purchase of audio gear that meets a user's criteria.

### BACKGROUND

The selection and purchasing of audio gear such as microphones, preamplifiers, amplifiers, and related equipment in the audio recording chain can be difficult. For example, in the case of microphones, each microphone has a different performance and thus sound characteristic. The difference in sound characteristics of microphones may be slightly discernible or significantly discernible. Further, the same microphone can perform quite differently depending upon the type of music or the voice being recorded. So a microphone that is suitable for one type of music may not be suitable for another type of music.

Someone purchasing new audio gear can make a selection based on past experience with the same audio gear and/or based on a recommendation. However, in the case of microphones, experimenting with other types of microphones that the user is not familiar with can be difficult because in the industry the current standard for a vocal microphone is that a purchaser cannot return the microphone once it is purchased. This limits the ability of a user to try new equipment in the audio recording chain, and perhaps discover a new piece of equipment that works better for the user's needs.

### SUMMARY

A system and method are described that allow users to directly compare audio gear, for example microphones and other items in the audio recording chain (e.g. preamplifiers, cables, amplifiers, etc.), against the same instance of recorded material and equidistant from the source material. The system and method allow a user to make the comparison against “bed music” tracks giving the user a representation of how the audio gear being compared will perform in the end product or music mix. By providing the user the ability to make an “apples-to-apples” comparison between audio gear, users are able to determine the audio gear that best meets their needs before making a purchase.

The system and method are provided to the user via a graphical user interface on a display device of a computer, mobile device, television or any other display device that can display a graphical user interface. For example, the system and method can be implemented as a web-based application that can run on conventional computers and displayed on the computer's display device using a web browser such as a personal computer, a laptop computer, or the like, or on a mobile device using the web browsing function of the mobile device. As of the filing date of this application, examples of mobile devices intended to be included herein include, but are not limited to, tablet computers such as the iPad™ line of tablet computers, smartphones such as the iPhone™ line of smartphones, and those mobile devices whether tablet computers or smartphones using the Android™ operating system or any suitable operating system. In one non-limiting example, the computer or mobile device should be capable of running Adobe Flash Player.

The system and method can also be implemented using a suitable application that is downloadable onto a user's mobile device, via a software program that is downloaded onto the user's conventional computer, or via a software program stored on a suitable memory device running on the user's computer. In non-web based situations, a user can be provided the ability to access a web-site where the software program can be updated or be provided with upgrades on memory devices such as CD's or flash drives.

In addition, the system and method can be implemented on a software program running on a computing device (e.g. installed in memory of the computing device or running on a memory device interfaced with the computing device) installed in a retail store or the like that a user visiting the retail store can an access and conduct the desired comparison(s).

Other ways of providing a user access to the system and method can be used.

In one embodiment, a method is provided that facilitates user selection of audio gear. The audio gear can be a microphone or any other items in the audio recording chain (e.g. preamplifiers, cables, amplifiers, etc.). The method includes providing to a user a graphical user interface displayed on a display device. The graphical user interface presents to the user a plurality of item track channels that can be selected by the user. Each item track channel is associated with a different item of audio gear, but each item of audio gear has been used to record the same audio material. When each item track channel is selected, the same audio material recorded using the respective associated item of audio gear is replayed allowing a user to hear the same audio material recorded from each item of audio gear. This permits the user to directly compare each item of audio gear against the same instance of recorded audio material and equidistant from the source audio material. Preferably, the items of audio gear up for comparison simultaneously record the same source audio material to even further eliminate possible variances in the recording process. The items of audio gear presented for comparison are presented to the user substantially uniformly giving no one item of audio gear an unfair advantage over the other.

The user listens to the recorded audio material using the speaker device(s) associated with the computer or other device that displays the graphical user interface. The user can also listen to the recorded audio material by plugging in headphones into a suitable port provided on the computer or other device that displays the graphical user interface. The user can also listen to the recorded audio material for each item of audio gear via Bluetooth or other wireless technology.

In another embodiment, the method allows the user the conduct an A/B comparison between items of audio gear by selecting two of the item track channels so that the items of audio gear associated with the selected item track channels are part of the A/B comparison. The user can change the item track channels and thus the items of audio gear that are part of the A/B comparison, enabling the user to compare all of the items of audio gear and select the audio gear preferred by the user.

In one embodiment, details of the audio gear items corresponding to the selected item track channels are displayed on the user interface while the user is conducting the comparison. This permits the user to know which items of audio gear are currently being compared.

Alternatively, in another embodiment, the comparison can be done blindly whereby no details of the audio gear items corresponding to the selected item track channels are displayed. This eliminates potential bias of the user that could occur if the user knows which item(s) of audio gear is being heard.

In another embodiment, a method is provided for generating recorded audio material for use in the audio gear selection method. To generate the recorded audio material, a plurality of items of the audio gear, for example microphones, to be included in the audio gear selection method are mounted in an array so that the microphones are set on the same vertical and horizontal plane and substantially equidistant from the audio source material. In this manner, each microphone in the array receives the audio source material at the same time, so that each item of audio gear, in this example microphones, in the audio gear selection method can accurately and fairly present reproduction of the audio source material to the user for selection.

The method for generating recorded audio material is achieved using an innovative audio gear mounting system which can be used in combination with a cable strain relief structure.

### DRAWINGS

FIG. 1 graphically depicts a main user interface screen of an exemplary user interface that would be displayed to a user on a display device.

FIG. 2 graphically depicts another user interface screen that the user sees when one of the item track channels is selected.

FIG. 3 graphically depicts another user interface screen that the user sees when an A item track channel is selected for an A/B comparison.

FIG. 4 graphically depicts another user interface screen that the user sees when both an A item track channel and a B item track channel are selected for the A/B comparison.

FIG. 5 is a perspective view of an audio gear mounting system and a cable strain relief structure that can be used during generation of recorded audio material.

FIG. 6 illustrates the audio gear mounting system of FIG. 5.

FIG. 7 illustrates the cable strain relief structure of FIG. 5.

### DETAILED DESCRIPTION

A system and method are described that allow users to directly compare audio gear, for example microphones and other items in the audio recording chain (e.g. preamplifiers, cables, amplifiers, etc.), against the same instance of recorded material and substantially equidistant from the source audio material. In one embodiment, the audio gear used in the comparison simultaneously record from the same audio source material (i.e. in the case of microphones, the microphones are all mounted together, and simultaneously record from the same audio source material). The system and method allow a user to make the comparison against “bed music” tracks giving the user a representation of how the compared items of audio gear will perform in the end product or music mix. By providing the user the ability to make an “apples-to-apples” comparison between audio gear, users are able to determine the item(s) of audio gear that best meets their needs before making a purchase.

The system and method are provided to the user via a graphical user interface on a display device of a computer, mobile device, television or any other display device that can display a graphical user interface. The user can interact with the user interface using a conventional mouse and cursor device. Alternatively, the user interface can be presented on a touch screen type display where the user uses a stylus, their finger, or other element to interact with the user interface.

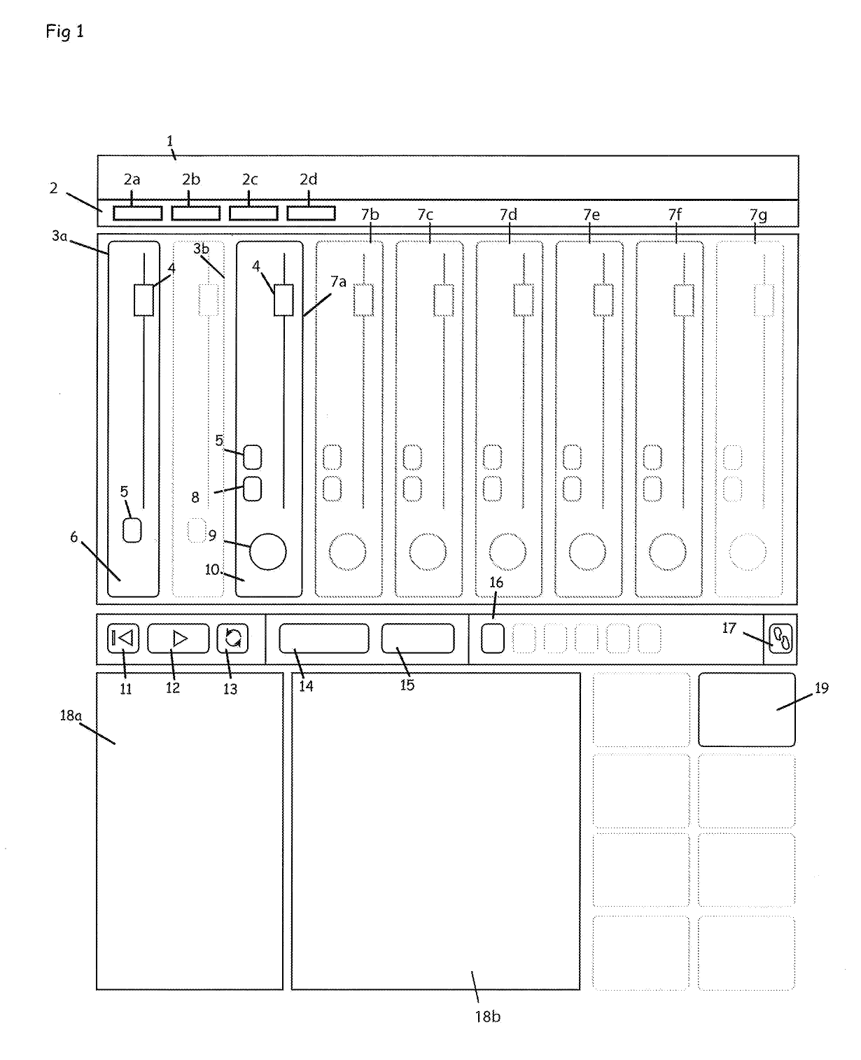

With reference to FIG. 1, a main user interface screen of an exemplary user interface that would be displayed to a user on a display device is illustrated. The main user interface screen includes a title bar 1 that can include one or more display elements such as, but not limited to, the session title, and session information including, but not limited to, audio file type (for example mp3 or way file), bit rate, date of recording, date of posting, genre, and artist.

Beneath the title bar 1 is a menu bar 2 with user selectable menu options Track Select 2a, Sort By 2b, Options 2c, and Help 2d. When one of the menu options is selected by clicking on the desired menu option, a drop down menu is provided to the user allowing the user to select an item from the drop down menu.

For example, when the user selects the Track Select 2a menu option, the user is presented with options to add and remove tracks from sessions to accommodate different computer system capabilities.

When the user selects the Sort By 2b menu option, the user is presented with options to sort the items of audio gear by, for example, price, model, ratings, item type and manufacturer.

When the user selects the Options 2c menu option, the user is presented with options that allow the user to activate features of the applications including tooltips, user ratings and comments and a feature called listen blind. As will be discussed further below, the listen blind removes all information regarding the items of audio gear from the user interface and shuffles the audio gear tracks so users can evaluate the audio performance of the audio gear without visual bias regarding model and manufacturer.

When the user selects the Help 2d menu option, the user is presented with information regarding the site hosting the user interface, membership opportunities for accessing the user interface, a glossary, tutorials and application version.

The items presented to the user in each drop down menu of the menu options can vary from those described herein.

Returning to FIG. 1, the main user interface screen also displays two bed track channels 3a, 3b. The bed track channels provide supporting audio source material for the audio gear tracks in the session, such as bass and drums, vocals or reverb. Although the user interface is shown as having two bed track channels 3a, 3b, a larger or smaller number of bed track channels can be provided.

Each bed track channel 3a, 3b can be selected by the user by “clicking” on the desired bed track channel with the selected bed track channel then becoming active (shown in dark lines for bed track channel 3a) while the other bed track channel is inactive (shown in pale lines for bed track channel 3b).

Each bed track channel 3a, 3b presents to the user a channel volume fader 4 that a user can slide up and down to adjust the channel volume either up (i.e. greater) or down (i.e. lower). In addition, the bed track channels 3a, 3b include a channel mute button 5 that sets the track volume to 0 while maintaining a record of the track volume to reset when turned off. Also, a bed track identifier 6 is provided for each bed track channel 3a, 3b that displays information identifying the particular bed track (for example bass and drums, vocals or reverb) associated with that channel.

A plurality of item track channels 7a-g are also presented to the user. FIG. 1 illustrates seven item track channels on the user interface. It is to be realized that a greater or lesser number of item track channels can be provided. However, it is preferred that there are at least two item track channels.

Each item track channel 7a-g is associated with a different item of audio gear such that by selecting one of the item track channels 7a-g, the user selects the item of audio gear associated therewith. Each item track channel 7a-g can be selected by the user by “clicking” on the desired item track channel with the selected item track channel then becoming active (shown in dark lines for item track channel 7a) while the other item track channels are inactive (shown in pale lines for item track channels 7b-g).

As will be discussed further below, each item of audio gear has been used to record the same audio material, preferably simultaneously. When one of the item track channels 7a-g is selected, the audio material or track that was recorded using the item of audio gear associated with the selected item track channel is replayed for the user to listen to. By selecting each item track channel 7a-g, the same audio material that was recorded using each of the separate items of audio gear is replayed for the user to listen to, allowing a user to listen to the same audio material recorded from each item of audio gear.

Like the bed track channels 3a, 3b, each item track channel 7a-g presents to the user a channel volume fader 4 that a user can slide up and down to adjust the channel volume either up (i.e. greater) or down (i.e. lower). In addition, the item track channels 7a-g include a channel mute button 5 that sets the track volume to 0 while maintaining a record of the track volume to reset when turned off. Also, an item track identifier 10 is provided for each item track channel 7a-g that displays information identifying the particular item of audio gear associated with that item track channel. For example, the item track identifier 10 can be the model, brand or other identifying information of the item of audio gear associated with the respective item track channel 7a-g.

The item track channels 7a-g also include an A/B selector button 8 that is used by the user to select an individual item track channel to compare the audio performance of its associated item of audio gear in an A/B comparison with the audio performance of a different item of audio gear associated with another selected item track channel. Clicking the A/B selector button 8 initiates the A/B compare active mode. Clicking the A/B selector button 8 again removes the audio gear of the selected item track channel from the A/B compare feature. Further, the item track channels 7a-g also include a stereo panning knob 9 that a user can use to control the audio pan (i.e. left and right).

Additional user interface controls include a reset audio button 11 that resets the audio source file or track from the beginning, an audio play button 12 that starts play of the audio source file/track, and a set loop mode button 13 which, when selected, will continuously loop active audio source files/tracks.

A session information button 14, when selected by the user, will cause technical information about the audio gear recording session to be displayed in a first display area 18a including date recorded, date posted, genre, etc. In addition, session notes and any special conditions regarding the audio source files, information on the items of audio gear used, information on the source audio material, etc. will be displayed in a second display area 18b.

An artist information button 15, when selected by the user, will cause an image of the artists and other artist information to be displayed in the display area 18a, and a signal chain to the audio source files will be displayed in display area 18b. All items in the signal chain display area 18b can be linked to retailer product databases, such as the retailer websites, that allow the user to access the retailer databases for each item of audio gear in the signal chain for possible purchase. In addition, a third display area 19 can display additional information such as the song's (bed track) artist information including band name, band website, and links to complete versions of the song on pay per song sites such as iTunes.

A plurality of item selector buttons 16 are also provided. The selector buttons 16 function together with a link channels button 17 that can be set by the user by clicking on the button 17 to be active or inactive. When the link channels button 17 is active, the item selector buttons 16 allow quick selection of item track channels 7a-g by clicking on one of the selector buttons 16. When the link channels button 17 is inactive, the user can preview information on the item of audio gear associated with each item track channel by clicking on one of the selector buttons 16 without changing the current active item track channel.

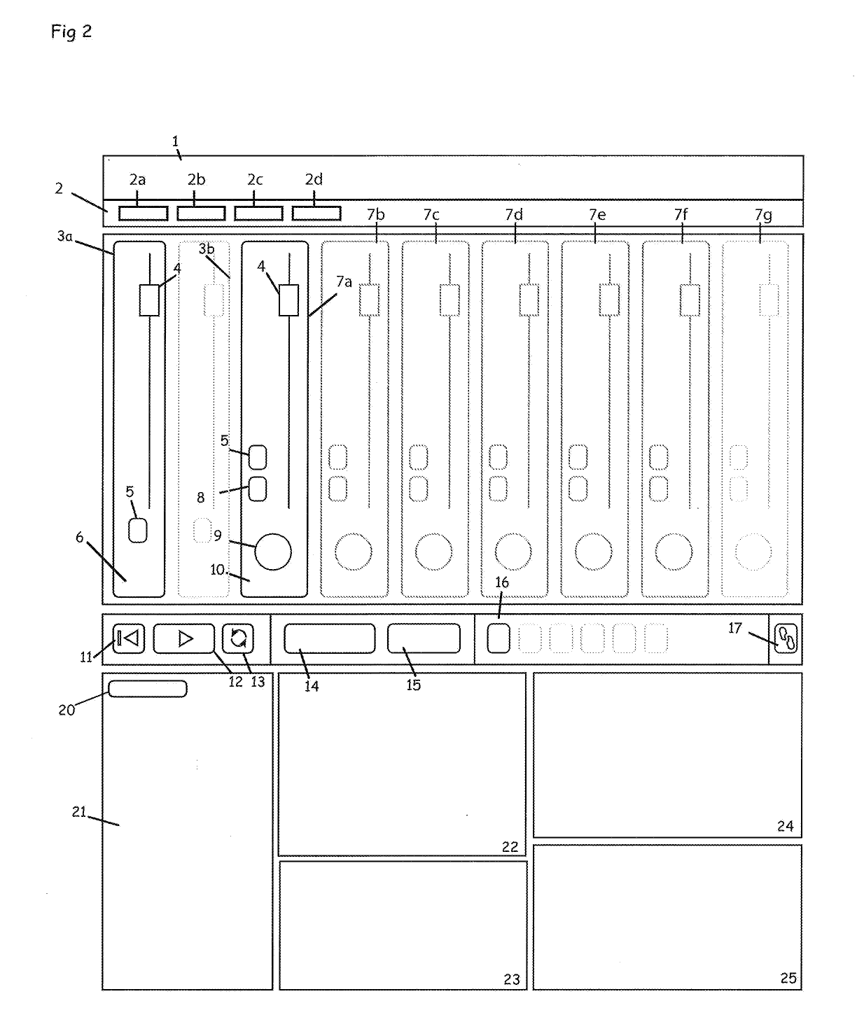

Turning now to FIG. 2, a user interface screen is illustrated that the user sees when one of the item track channels 7a-g is selected. As an example, FIG. 2 shows the item track channel 7a being selected, as indicated in dark/full lines. In FIG. 2, elements in common with elements in FIG. 1 are referenced using the same reference numerals.

As depicted in FIG. 2, when an item track channel is selected, the bottom portion of the user interface, including the first, second and third display areas 18a, 18b, 19 change. In their place, a compare item button 20 is displayed. The compare item button 20 selects the item of audio gear associated with the selected item track channel for use in the A/B compare function (which is same functionality as the A/B selector button 8). In addition, a number of display areas 21-25 are provided.

The display area 21 displays an image of the item of audio gear associated with the selected item track channel.

The display area 22 displays certain information regarding the audio gear item associated with the selected item track channel, such as manufactures item information, frequency response, power requirements, and the like.

The display area 23 displays information facilitating a purchase of the item of audio gear associated with the selected item track channel by the user, such as displaying the best price of the item and/or combination of extras provided by the retailor regarding purchase of the item. The display area 23 can also include an active link that when clicked takes the users directly to the retailers website and/or adds the item directly to a shopping cart.

The display area 24 displays information regarding related sessions to the current item of audio gear. For example, the display area 24 can display other audio sessions that are available for selection by the user where the current audio gear item is included in the set of audio gear items tested.

Further, display area 25 displays user content about the current item of audio gear. For example, the display area 25 can display user ratings regarding the current item, and display user comment regarding the item. In one embodiment, a link is provided that allows the user to click on the link which takes the user to all comments on the item. In addition, the user can click a link to allow the user to post their own comments on the item.

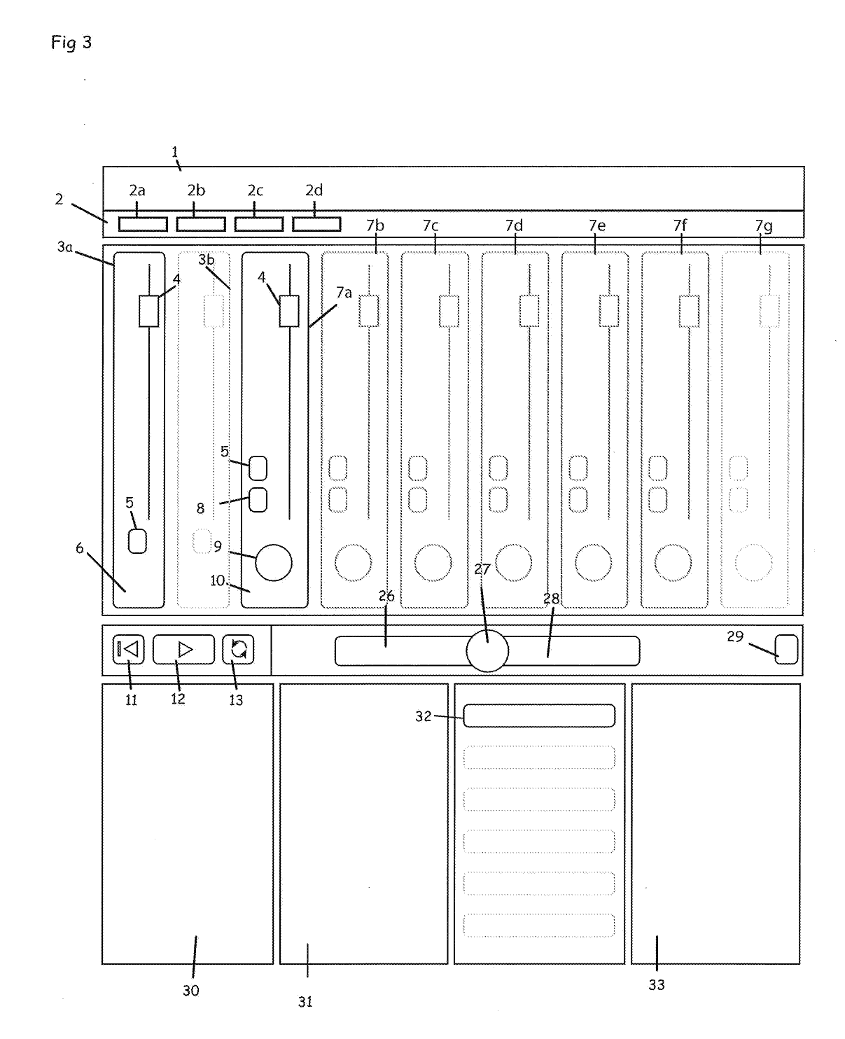

Turning now to FIG. 3, a user interface screen that the user sees when the user clicks on the A/B selector button 8 of one of the item track channels 7a-g for an A/B comparison is illustrated. As an example, FIG. 3 shows the A/B selector button 8 of item track channel 7a being selected, as indicated in dark/full lines. In FIG. 3, elements in common with elements in FIG. 1 are referenced using the same reference numerals.

As depicted in FIG. 3, when the A/B selector button 8 of an item track channel 7a-g is selected, the bottom portion of the user interface, including the first, second and third display areas 18a, 18b, 19 and the buttons 14-17 change. In their place, an A/B control area and a number of display areas 30-33 are provided.

The A/B control area includes a select item A button 26 that when clicked by the user sets the item of audio gear associated with the selected item track channel to the A item track and mutes B, a select item B button 28 that when clicked by the user sets the item of audio gear associated with another selected item track channel to the B item track and mutes A, and an A/B toggle items button 27 that when clicked by the user switches between item tracks A and B.

The buttons 26-28 only become active if two items of audio gear (i.e. associated with two simultaneously selected item track channels 7a-g) are selected for an A/B comparison using the A/B selector buttons 8. A close A/B view button 29 is also provided that when clicked by the user, closes the A/B compare function and resets the user interface, for example to the user interface shown in FIG. 2.

The display area 30 displays an image of the A item of audio gear that is part of the A/B comparison, while display area 31 displays certain information regarding the A item of audio gear, such as manufactures item information, frequency response, power requirements, and the like.

The display area 32 presents a plurality of buttons representing the remaining items of audio gear that can be used in the A/B comparison. Rolling over the buttons in the display area 32 displays an image of each of the remaining items of audio gear available for comparison in the display area 33. Clicking on one of the buttons in the display area 32 sets the corresponding item of audio gear for comparison as the B item of audio gear.

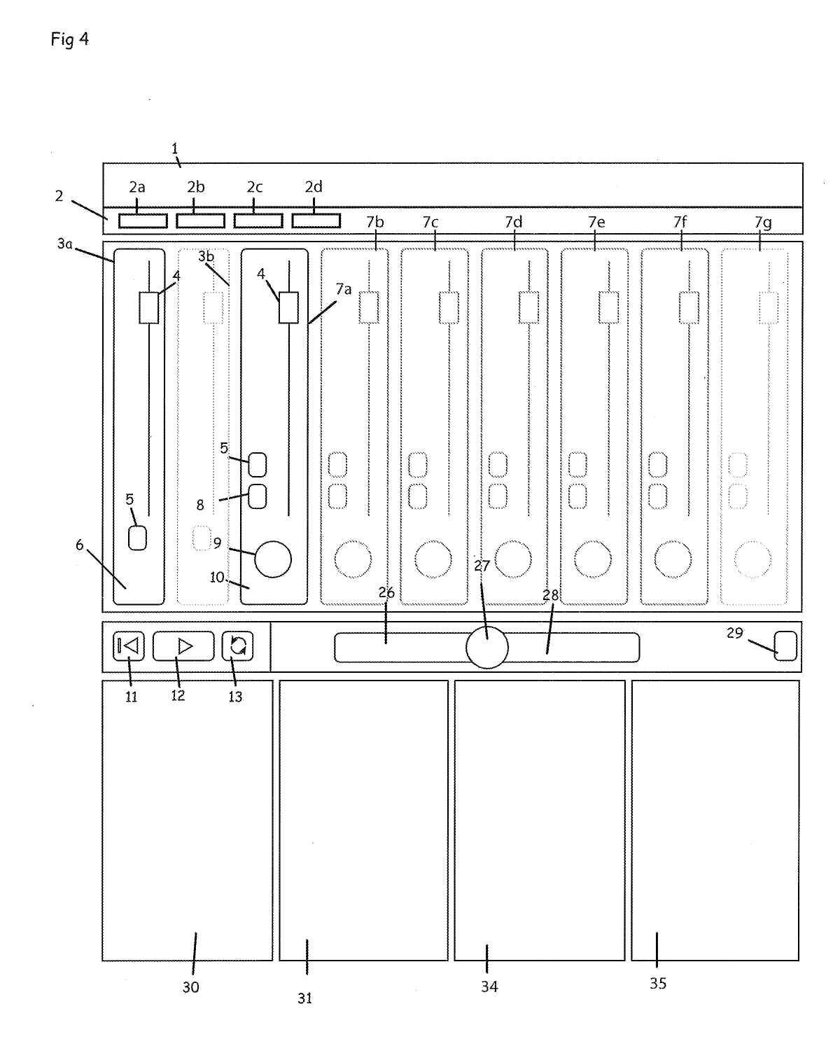

FIG. 4 graphically depicts the user interface screen that the user sees when both an A item track channel and a B item track channel are selected for the A/B comparison. In this example, the item track channel 7a and the item track channel 7g are selected. In FIG. 4, elements in common with elements in FIG. 3 are referenced using the same reference numerals.

In FIG. 4, the display areas 30, 31 continue to display the image and information regarding the A audio gear item. In addition, new display areas 34, 35 appear, with the display area 34 displaying certain information regarding the B audio gear item, such as manufactures item information, frequency response, power requirements, and the like, while the display area 35 displays an image of the B audio gear item. If desired, the display areas 30, 31 are only active (i.e. shown in dark lines) if the button 26 is selected while the display areas 34, 35 are grayed out (i.e. shown in light lines). Conversely, the display areas 34, 35 can become active (i.e. shown in dark lines) if the button 28 is selected with the display areas 30, 31 being grayed out (i.e. shown in light lines).

To avoid potential bias on the user that can occur because the user can see the brand, manufacturer and other information of each item of audio gear in the display areas 30, 31, 34, 35 while doing the comparison, the listen blind feature available in the menu options in the Options 2c menu option, can be employed. When the user selects the listen blind feature, all information and pictures relating to the items of audio gear involved in the comparison are removed from the display areas 30, 31, 34, 35 so that the user is not able to see any details of the items while conducting the A/B comparison.

Many other user options can be made available. For example, one option is a WAV (Waveform Audio File format) viewer that allows users to call up a digital view that represents the frequency response of each track's signal over time. Each track's WAV form will be slightly different and will demonstrate how each audio gear item effects, modifies or reproduces a given audio source.

Another option is a WAV form A/B viewer that allows users to have two WAV form patterns on the display simultaneously while in the A/B view. The WAV forms can be overlaid and users can be allowed to zoom in to a fine level to see how each audio sample instance is reproduced by the selected audio gear items in the master A/B view.

Another option is an audio selection loop trimmer that allows users to set a smaller timed selection of the total audio audition sound file. For example, a user may want to focus on a signal bass drum strike instead of the whole drum track. This will enable the user to minutely compare an audio gear item's response to the audio signal without the interference of any other sound source leakage.

To conduct the audio gear comparison and selection as described herein most accurately and fairly, each item of audio gear needs to reproduce the source audio material as equally as possible. In particular, each item of audio gear should be set-up to receive the source audio material at substantially the same time (i.e. the audio gear should be located substantially the same distance from the source audio material) and under essentially the same receiving conditions.

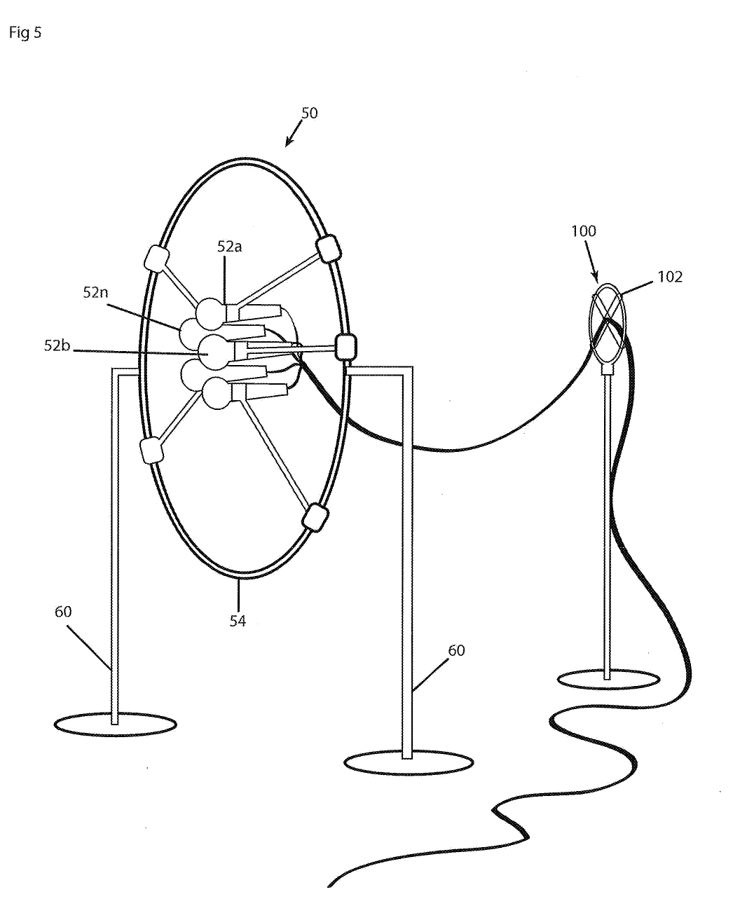

Therefore, as will be described below in conjunction with FIGS. 5-7, a method is provided for generating recorded material for use in the audio gear selection method. To generate the recorded material, a plurality of items of audio gear, for example microphones, to be included in the audio gear selection method of FIGS. 1-4 are mounted in an array so that the microphone are set on the same vertical and horizontal planes and equidistant from the source audio material. In this manner, each microphone in the array receives the source audio material substantially at the same time and under essentially identical receiving conditions, so that each of the items in the audio gear selection method can accurately and fairly present reproduction of the source audio material to the user during the comparison and selection of the audio gear.

With reference to FIGS. 5-7, the method for generating recorded material is achieved using an audio gear mounting system 50 which can be used in combination with a cable strain relief structure 100. The audio gear used with the mounting system 50 will hereinafter be described as being microphones. However, it is to be realized that similar concepts can be applied to other items in the audio recording chain including, but not limited to, preamplifiers, cables, amplifiers, etc.

The mounting system 50 is configured to mount at least two microphone 52a, 52b, . . . 52n in an array so that the microphone 52a,b, n are set on the same vertical and horizontal planes and equidistant from source audio material such as one or more musical instruments and/or a vocalist, a speaker playing music, etc.

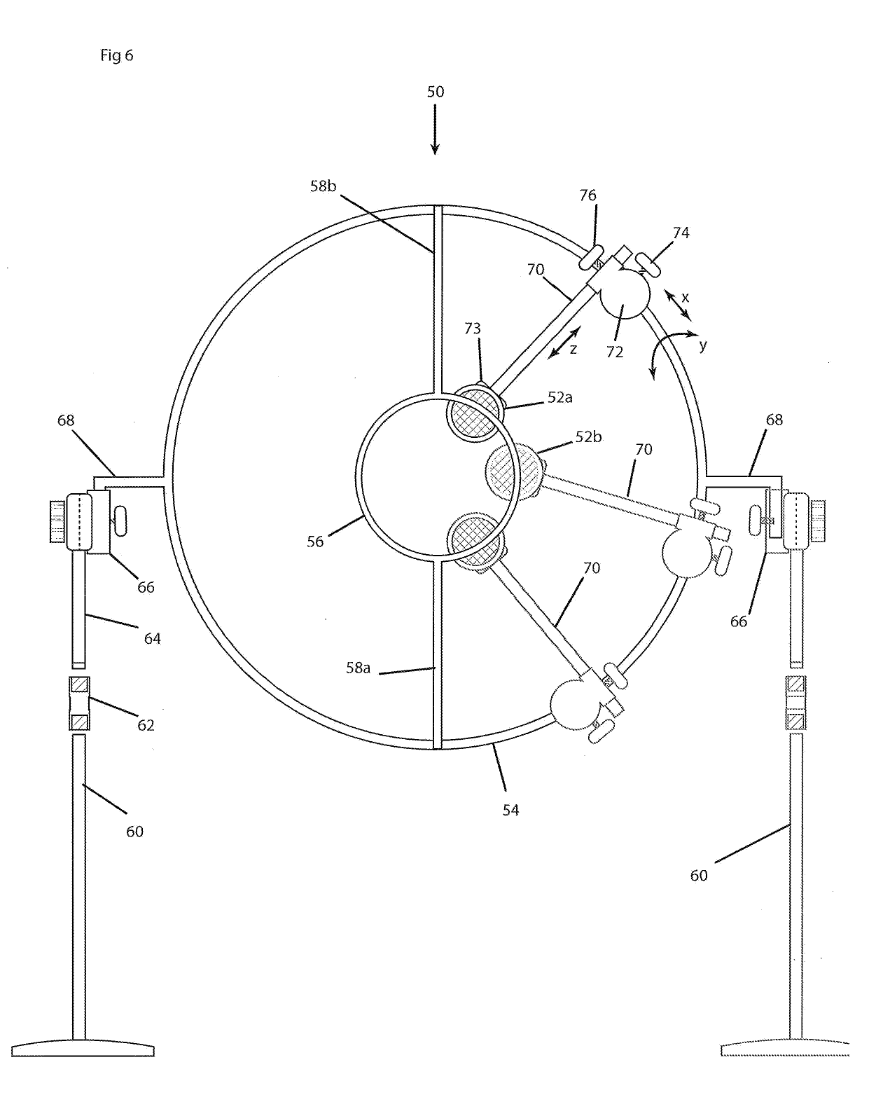

As illustrated in FIGS. 5 and 6, the microphones 52a, b, . . . n are arranged in a circular array. However, the array of microphones can be any shape as long as the microphones are set on the same vertical and horizontal planes and are equidistant from the source audio material. FIG. 5 illustrates five (5) microphones in the array. However, a larger or smaller number of microphones can be mounted in the array. The microphones are preferably different from one another, such as different brands of microphones from different manufacturers, different models of microphones from the same manufacturer, different microphones all within a certain price range, etc.

With reference to FIGS. 5 and 6, one illustrative example of the mounting system 50 is illustrated. In this example, the system 50 includes a substantially circular support ring 54 of any suitable construction, such as aluminum, other metal or plastic round stock. A centering ring 56 is mounted in the center of the support ring 54 by support arms 58a, 58b. Preferably, the centering ring 56 is detachable from the support ring 54 by making the support arms 58a, 58b detachable from the support ring 54. The centering ring 56 facilitates positioning of the microphone head elements (the part of the microphones that records the sound) accurately in the center of the support ring 54 and ensures that they are all on the same vertical plane by acting as a stop against which the microphone heads can abut and act as an alignment guide during mounting. Once the microphones are positioned, the centering ring 56 is removed so that it does not obstruct the sound.

To support the support ring 54, a pair of microphone stands 60 are disposed on each side of the support ring 54. The microphone stands 60 include a coupler 62 at the upper end thereof that couples to an extension 64. Each extension 64 includes a mounting clamp 66 that clamps to a mounting arm 68 extending from the support ring 54. In this manner, the support ring 54 is mounted and supported between the microphone stands 60.

The microphones 52a, b, . . . n are mounted via mounting arms 70 fixed to mounting clamps 72. The clamps 72 are slidably disposed on the ring 54 to allow the circumferential positions of the clamps 72 on the ring 54 to be adjusted in the direction of the arrows X and fixed in position using threaded member 74. In addition, the angular tilt of each microphone in the direction of the arrows Y into and out of the page when viewing FIG. 6 can be adjusted by loosening the member 74 and rotating the clamp 72 about the ring 54. The radial position (i.e. the distance away from the ring 54) of each microphone can be adjusted in the direction of the arrows Z by loosening the threaded member 76 and sliding the mounting arm 70 up or down relative to the clamp 72. This multiple adjustment of the microphones permits the microphones to be set on the same vertical and horizontal planes and equidistant from the source audio material.

The microphones 52a, b, . . . n can be mounted to the inner ends of the mounting arms 70 using any suitable mounting structure known in the art for mounting microphones to support members. For example, each microphone can be mounted in position at the end of the arm 70 via a supplied manufacture's clip that comes with the microphone. Each microphone 52a, b, . . . n is pivotally mounted to the end of the respective arm 70 to allow the microphone to be tilted in an arch relative to the end of the arm 70 as its pivot point.

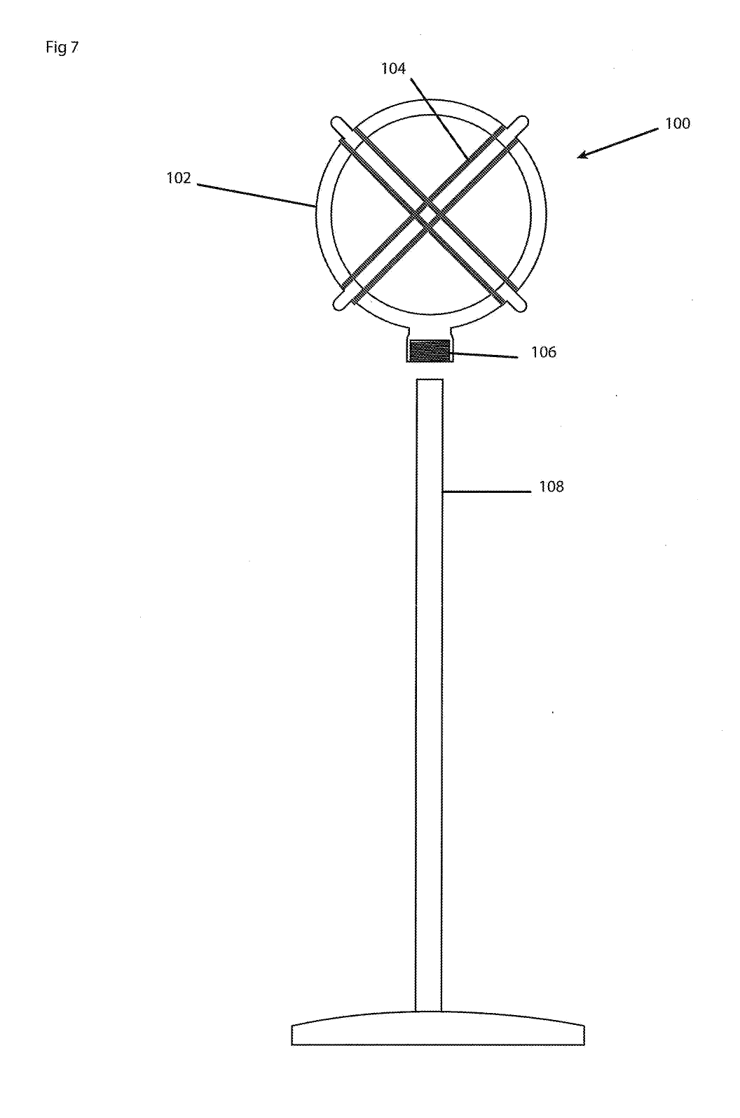

When all of the microphones are arranged in the array, the corresponding microphone cables, as a group, can get heavy enough so that when hanging freely they can knock the microphones or the ring 54 out of position. With reference to FIGS. 5 and 7, the cable strain relief structure 100 is intended to prevent this by supporting the cable group and prevent its weight from affecting the support ring 54 or the array of microphones. The structure 100 includes a cable strain relief ring 102 and a plurality of elastic supports 104 that support the microphone cables. The elastic supports 104 help ensure that the cables do not generate any noise from vibration during a recording session.

The ring 102 further includes a mounting structure 106, such as a microphone stand mounting insert, at the base thereof that is configured to detachably connect to a support structure 108 such as a microphone stand.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of permitting user selection of an item of audio gear, comprising:
providing to the user a graphical user interface displayed on a display device, the graphical user interface presenting to the user a plurality of item track channels that can be selected by the user, each item track channel is associated with a different item of audio gear, each different item of audio gear has recorded the same audio material, and each item track channel, when selected, replays the same audio material recorded using the respective associated item of audio gear to allow a user to hear the same audio material recorded from each item of audio gear.

2. The method of claim 1, further comprising allowing the user to physically select two of the item track channels to permit the user to conduct an A/B comparison between the two items of audio gear associated with the two selected item track channels.

3. The method of claim 2, further comprising allowing the user to physically select a listen blind mode to allow the user to conduct the A/B comparison without seeing details of the two items of audio gear.

4. The method of claim 1, further comprising allowing the user to select a WAV viewer that displays a graphical view on the graphical user interface of the frequency response of a selected item of audio gear over time.

5. The method of claim 2, further comprising allowing the user to select a WAV form A/B viewer that displays two WAV form patterns of the two selected item track channels on the graphical user interface simultaneously while conducting an A/B comparison.

6. The method of claim 1, further comprising allowing the user to set a smaller timed selection of the recorded audio material.

7. The method of claim 1, wherein the items of audio gear comprise microphones, preamplifiers, amplifiers, or cables.

8. A method comprising:
simultaneously recording the same audio material using a plurality of different items of audio gear;
associating an item track channel with each different item of audio gear;
allowing a user to simultaneously display each item track channel on a display device;
allowing a user to select one of the item track channels displayed on the display device; and
when the one item track channel is selected by the user, replaying the audio material recorded using the item of audio gear associated with the selected item track channel to allow the user to hear the audio material recorded from that associated item of audio gear.

9. The method of claim 8, wherein the items of audio gear are microphones, and simultaneously recording comprises arranging the microphones equidistant from source audio material.

10. The method of claim 9, further comprising arranging the microphones on the same vertical and horizontal plane.

11. The method of claim 8, further comprising allowing the user to select two of the item track channels, and separately replaying the audio material recorded using the two items of audio gear associated with the two selected item track channels to permit the user to conduct an A/B comparison between the two items of audio gear associated with the two selected item track channels.

12. The method of claim 11, further comprising allowing the user to select a listen blind mode to allow the user to conduct the A/B comparison without seeing details of the two items of audio gear.

13. The method of claim 8, further comprising allowing the user to select a WAV viewer that when selected displays a graphical view, on the display device, of the frequency response of the item of audio gear associated with the selected item track channel over time.

14. The method of claim 11, further comprising allowing the user to select a WAV form A/B viewer that when selected displays two WAV form patterns of the two selected item track channels on the display device simultaneously while conducting an A/B comparison.

15. The method of claim 8, further comprising allowing the user to set a smaller timed selection of the recorded audio material that is replayed when the one item track channel is selected.

16. The method of claim 8, wherein the items of audio gear comprise microphones, preamplifiers, amplifiers, or cables.

17. A method, comprising:
mounting a plurality of different microphones in an array on a support structure so that the microphones are set on the same vertical and horizontal planes and equidistant from a source of audio material;
generating audio material using the source; and
simultaneously recording the audio material generated by the source using the plurality of microphones.

18. The method of claim 17, further comprising:
associating an item track channel with each microphone;
simultaneously displaying each item track channel on a display device;
allowing a user to select one of the item track channels displayed on the display device; and
replaying the audio material that was recorded using the microphone associated with the selected item track channel.

19. The method of claim 18, further comprising allowing the user to select two of the item track channels; replaying the audio material that was recorded using the microphone associated with a first one of the two selected item track channels; and shortly thereafter replaying the audio material that was recorded using the microphone associated with the second of the two selected item track channels.

20. The method of claim 18, comprising replaying the audio material without displaying details of the microphone on the display device.
